(19) United States
(12) Patent Application Publication
(10) Pub. No.: US 2014/0267105 A1
(43) Pub. Date: Sep. 18, 2014

(54) DRAWING DEVICE, DISPLAY METHOD, AND RECORDING MEDIUM

(71) Applicant: Sharp Kabushiki Kaisha, Osaka (JP)

(72) Inventor: Kohji KUMETANI, Osaka-shi (JP)

(73) Assignee: Sharp Kabushiki Kaisha, Osaka (JP)

(21) Appl. No.: 14/202,061

(22) Filed: Mar. 10, 2014

(30) Foreign Application Priority Data
Mar. 12, 2013 (JP) 2013-049649

(51) Int. Cl. G06F 3/041

(52) U.S. Cl. CPC G06F 3/0416
USPC 345/173

(57) ABSTRACT

Disclosed is a drawing device having a display screen for displaying images based on instructions received from a plurality of drawers each having its own identification data and issuing the instructions relating to drawings. The drawing device includes a touch panel section configured to detect positions of respective drawers on the display screen, and a display control section configured to display setting receiving images for receiving settings relating to drawings, by as many as the number of drawers based on the detected positions of the drawers.

### CROSS-REFERENCE TO RELATED APPLICATIONS

This Nonprovisional application claims priority under 35 U.S.C. §119(a) on Patent Application No. 2013-49649 filed in Japan on Mar. 12, 2013, the entire contents of which are hereby incorporated by reference.

### BACKGROUND OF THE INVENTION

1. Technical Field

The present invention relates to a drawing device having a display screen for displaying images based on instructions received from a plurality of drawers each having its own identification data and issuing the instructions relating to drawings.

2. Description of the Related Art

Recently, an interactive whiteboard used for a collective conference, or the like, has been widely spread. Most of the interactive whiteboards include: a large display screen; and a touch panel detecting coordinates of an input position, so as to sequentially read information on coordinates regarding an input position and movement of a pen type input device, and perform a drawing on the display screen based on the read information.

Japanese Patent Laid-Open Publication No. H08-320755 discloses an information processer which displays icons, and the like, relating to processing commands adjacent to the pen type input device on the condition that one user uses the pen type input device.

### SUMMARY OF THE INVENTION

Meanwhile, there may be the case in which a plurality of users perform drawing on a display screen when the display screen is large. However, since such an above-described conventional interactive whiteboard and the information processer disclosed in Patent Document 1 define the condition that one user uses the pen type input device, as described above, these whiteboard and processer may not cope with the case in which a plurality of users perform drawing, in other words, the case in which a plurality of pen type input devices are used.

In consideration of the above-described circumstances, it is an object of the present invention to provide a drawing device having a display screen for displaying images based on instructions received from a plurality of drawers each having its own identification data and issuing the instructions relating to drawings, in which the drawing device detects positions of respective drawers on the display screen and displays a setting receiving image for receiving settings relating to drawing, by as many as the number of drawers based on the detected positions of the drawers, thereby it is possible to cope with the case in which the plurality of drawers are used, and improving convenience of each user when a plurality of users are drawing.

In order to achieve the above object, according to an aspect of the present invention, there is provided a drawing device having a display screen for displaying images based on instructions received from a plurality of drawers each having its own identification data and issuing the instructions relating to drawings, the drawing device including: a touch panel section configured to detect positions of respective drawers on the display screen; and a display control section configured to display setting receiving images for receiving settings relating to drawings, by as many as the number of drawers based on the detected positions of the drawers.

According to the present invention having the above configuration, the touch panel section detects the positions of respective drawers on the display screen. The number of drawers may be specified based on the positions of the drawers detected by the touch panel section, and therefore the display control section displays the setting receiving images on the display screen by as many as the number of drawers.

In the drawing device according to the present invention, further including an acquisition section configured to acquire identification data from the respective drawers, wherein the display control section displays the corresponding setting receiving image within a specific range from positions of the respective drawers based on the acquired identification data and the detection result of the touch panel section.

According to the present invention having the above configuration, when the touch panel section detects the positions of respective drawers, the acquisition section acquires the identification data relating to the respective drawers. In this case, the display control section displays the respective setting receiving images corresponding to the respective drawers within the specific range from the positions of the respective drawers on the display screen, based on the acquired identification data and the detection result of the touch panel section.

In the drawing device according to the present invention, further including a decision section configured to decide a position at which the setting receiving image is displayed; and a determination section configured to determine whether to change the position when another setting receiving image has been already displayed at the position decided by the decision section, wherein if the determination section determines that the position can be changed, the decision section changes the position.

According to the present invention having the above configuration, when the decision section decides a prescribed position as the position at which the setting receiving image is to be displayed, the determination section determines another setting receiving image is already displayed at the decided prescribed positions. For example, if it is determined that other setting receiving image has been already displayed, the determination section determines that the decided prescribed positions may be changed. If the determination section determines that the prescribed positions decided by the decision section may be changed, the decision section performs a re-determination so as not to overlap with the other setting receiving images.

In the drawing device according to the present invention, if the determination section determines that the position cannot be changed, the display control section displays the setting receiving image to be displayed in a semi-transparent manner.

According to the present invention having the above configuration, if the determination section determines that the positions decided by the decision section may not be changed, the display control section displays the setting receiving image to be displayed in a semi-transparent manner over another setting receiving images that have already been displayed.

In the drawing device according to the present invention, further including a selection receiving section configured to receive a selection as to whether another drawer ends drawing when an instruction to end drawing relating to any drawer is received, wherein the execution of drawing is ended based on the selection received by the selection receiving section.

According to the present invention having the above configuration, for example, when a user of any one drawer of the plurality of drawers gives an instruction of intent to end drawing, and if the drawing device receives such an instruction, the drawing device urges a user of another drawer to select whether to end the execution of drawing. When the selection receiving section receives the selection as to whether the other drawer ends drawing from the user thereof, the execution of drawing may be ended based on the selection received by the selection receiving section.

According to the present invention, the drawing device detects the positions of the plurality of the drawers on the display screen and displays the setting receiving image by as many as the number of drawers based on the detected positions of the respective drawers, thereby it is possible to cope with the case in which the plurality of drawers are used and improve convenience of each user when a plurality of users perform the drawing.

The above and further objects and features will more fully be apparent from the following detailed description with accompanying drawings.

### BRIEF DESCRIPTION OF THE SEVERAL VIEWS

FIG. 1 is a view conceptually illustrating an interactive whiteboard according to an embodiment of the present invention.

FIG. 2 is a functional block diagram illustrating a configuration of major parts of the interactive whiteboard according to the embodiment of the present invention.

FIG. 3 is a functional block diagram illustrating a configuration of major parts of a control section in the interactive whiteboard according to the embodiment of the present invention.

FIG. 4 is a view for explaining the determination of a display position of a setting menu in the interactive whiteboard according to the embodiment of the present invention.

FIG. 5 is a functional block diagram for explaining the scanning processing of light in a touch panel section of the interactive whiteboard according to the embodiment of the present invention.

FIG. 6 is a view for explaining scanning and detection of a contact position between light shielding objects in the interactive whiteboard according to the embodiment of the present invention.

FIG. 7 is a flow chart for explaining the drawing processing performed by the interactive whiteboard according to the embodiment of the present invention.

FIG. 8 is a flow chart for explaining a display of a setting menu and a drawing performed by the interactive whiteboard according to the embodiment of the present invention.

FIG. 9 is a view illustrating an example of the display of the setting menu and the drawing performed by the interactive whiteboard according to the embodiment of the present invention.

FIG. 10 is a flow chart for explaining the display of the setting menu performed by the interactive whiteboard according to the embodiment of the present invention.

FIG. 11 is a view for explaining the display of the setting menu performed by the interactive whiteboard according to the embodiment of the present invention.

### DETAILED DESCRIPTION

Hereinafter, a drawing device according to embodiments of the present invention which is applied to a so-called interactive whiteboard will be described with reference to the accompanying drawings.

FIG. 1 is a view conceptually illustrating an interactive whiteboard 100 according to an embodiment of the present invention. The interactive whiteboard 100 according to the embodiment of the present invention is configured to perform a drawing using a plurality of pen type input devices 200 and 300 (drawers).

That is, the interactive whiteboard 100 according to the present invention performs the drawing processing depending on instructions (hereinafter, referred to as a drawing instruction) relating to drawings from the pen type input devices 200 and 300.

Further, the pen type input devices 200 and 300 are configured to wirelessly communicate with the interactive whiteboard 100 and when transmitting the drawing instruction, transmit together with their own identification data for specifying the input devices. Therefore, the interactive whiteboard 100 may confirm which of the pen type input device serves as a transmission source of the drawing instruction. The interactive whiteboard 100 stores the received drawing instruction in relation to the pen type input device (identification data) which is the transmission source thereof.

The interactive whiteboard 100 includes a display section 100A which has a rectangular display screen 101 displaying a diagrammatic drawing by the drawing processing and a touch panel section 100B which detects positions of the pen type input devices 200 and 300 or receives a position designation of a prescribed position on the display screen 101 by a method to be described below.

The touch panel section 100B according to the embodiment of the present invention is a so-called infrared intercepting type touch panel which includes a light emitting element emitting an infrared ray and a light receiving element receiving the infrared ray to detect a position of a light shielding object.

FIG. 2 is a functional block diagram illustrating a configuration of major parts of the interactive whiteboard 100 according to the embodiment of the present invention.

The display section 100A includes the display screen 101 such as an LCD or an electro luminescence (EL) panel, or the like and displays characters and diagrams on the display screen 101 based on the drawing instruction transmitted from the pen type input devices 200 and 300 and the detected result of the positions of the pen type input devices 200 and 300 by the touch panel section 100B. Further, the touch panel section 100B includes a scanning section 9.

In addition, the interactive whiteboard 100 includes a control section 1, a ROM 2, a RAM 3, a communication section 5, and a storage section 6. The interactive whiteboard 100 receives data relating to drawing, drawing instructions, identification data, and the like from the pen type input devices 200 and 300 through the communication section 5.

The control section 1 instructs the display section 100A to draw characters, diagrams, and the like based on coordinates relating to a result scanned by the scanning section 9 and the display section 100A displays the characters, the diagrams, and the like on the display screen 101 based on the instructions.

The ROM 2 is stored with a control program in advance and the RAM 3 may temporarily store data and read the data independent of a storage order, a storage position or the like. Further, the RAM 3 stores, for example, a program read from the ROM 2, various data, and the like generated by performing the program.

The control section 1 loads the control program pre-stored in the ROM 2 onto the RAM 3 and performs it, so as to control various types of above-described hardware via a bus to operate the interactive whiteboard 100.

The communication section 5 receives the drawing instruction, the identification data, and the like from the pen type input devices 200 and 300. The communication section 5 is configured to perform wireless communications, such as Bluetooth (registered trademark), Zigbee (registered trademark), or the like corresponding to communication sections of the pen type input devices 200 and 300.

The storage section 6 includes non-volatile storage media, such as a flash memory, an EEPROM (registered trademark), an HDD, a magnetoresistive memory (MRAM), a ferroelectric RAM (FeRAM), OUM, or the like. Further, the storage section 6 stores the corresponding drawing instructions, and the like for each identification data received from the pen type input devices 200 and 300. Further, the storage section 6 is stored with applications for executing drawing processing.

FIG. 3 is a functional block diagram illustrating a configuration of major parts of the control section 1 in the interactive whiteboard 100 according to the embodiment of the present invention. The control section 1 includes a CPU 11, a coordinate detection section 12, a light shielding object management section 13, an information integration section 14, an acquisition section 15, a drawing section 16, a display control section 17, a decision section 18, a determination section 19, and a selection receiving section 20.

The coordinate detection section 12 detects coordinates of the light shielding object (for example, pen type input devices 200 and 300) on the display screen 101. In detail, such coordinates of the light shielding objects are detected based on an intensity signal to be described below, which is transmitted when the light shielding on the display screen 101 of the display section 100A is detected by the touch panel section 100B.

The light shielding object management section 13 manages a position (coordinates) of the light shielding object which is detected by the scanning of the scanning section 9. For example, the light shielding object management section 13 stores a coordinate history representing a moving trace of the light shielding object when such light shielding object moves.

The information integration section 14 integrates the coordinates detected by the coordinate detection section 12 and the data relating to drawing instruction received from the pen type input devices 200 and 300 through the communication section 5 to generate the drawing data relating to drawing processing.

The acquisition section 15 receives and acquires each identification data from the pen type input devices 200 and 300 through the communication section 5 and stores the acquired identification data in the storage section 6.

The drawing section 16 generates an image to be displayed on the display screen 101 based on the drawing data generated by the information integration section 14 by using the applications for executing the drawing processing stored in the storage section 6 and outputs the generated image to the display screen 101 as an image signal, thereby performing drawing.

The display control section 17 displays a setting menu (a setting receiving image) which is a window for receiving settings relating to drawing from a user on the display screen 101. The setting menu is provided with a soft key to receive the setting, such as a color, a deletion, and an ending of the drawing.

In more detail, the display control section 17 displays the setting menu at the position decided by the decision section 18, changes the position of the setting menu already displayed and displays the setting menu at the changed position based on the detection result of the position of the pen type input devices 200 and 300 by the touch panel section 100B, and displays the setting menu in a semi-transparent manner based on the determination result by the determination section 19. Further, the display control section 17 displays an ending confirmation notice image to be described below under a specific condition.

The selection receiving section 20 receives a selection on whether or not to end drawing from the user of the pen type input device 200 or 300 through the ending confirmation notice image.

That is, when, in order to end drawing, a user of any pen type input device (for example, the pen type input device 200) turns off task switch mounted on the pen type input device 200 or when the user gives an instruction (a drawing end instruction) of intent to end drawing through the setting menu, the display control section 17 displays the ending confirmation notice image on the display screen 101. The ending confirmation notice image is provided with a text querying whether or not to end the execution of drawing (the drawing processing), soft keys of ‘Yes’ and ‘No’ for receiving the selection of the user or the like, and is displayed to a user (for example, the pen type input device 300) other than the user instructing the drawing ending. The ending confirmation notice image is displayed near, for example, the setting menu.

The decision section 18 decides the position at which the setting menu is displayed. The decision section 18 decides the display position of the setting menu based on the position detection result of the pen type input device by the touch panel section 100B.

FIG. 4 is a view for explaining the determination of the display position of the setting menu in the interactive whiteboard 100 according to the embodiment of the present invention.

For example, when the touch panel section 100B detects the position of the pen type input device 200 in the display screen 101, the decision section 18 decides whether the detected position (hereinafter, referred to as a detection position) of the pen type input device 200 is at the left or right of the display screen 101. If it is determined that the detection position is at the left of the display screen 101, the position at 20 cm to the left from the detection position is determined to be the position at which the setting menu is to be displayed, and if it is determined that the detection position is at the right of the display screen 101, the position at 20 cm to the right from the detection position is determined to be the position at which the setting menu is to be displayed. The position (hereinafter, referred to as a decision display position) determined by the decision section 18 is stored in the storage section 6 in relation to the pen type input device 200 (identification data).

The determination section 19 confirms whether another setting menu is already displayed at the decision display position decided by the decision section 18 as the position at which the setting menu is to be displayed based on the decision display position stored in the storage section 6, and if it is determined that another setting menu is already displayed, determines whether or not to change the decision display position.

For example, when the detection position of the pen type input device 300 is at the left of the display screen 101, the decision section 18 decides the position at 20 cm to the left as the decision display position (a first position). But, it is also assumed possible the case in which the setting menu relating to the pen type input device 200 is already displayed at that position (see FIG. 4). In this case, to avoid overlapping the setting menu relating to the pen type input device 200, the decision section 18, for example, re-decides a position (a second position) at a prescribed distance separated from the first position more to the left and the determination section 19 again performs the determination. However, as illustrated in FIG. 4, since the second position, that is, the more left from the first position at which the setting menu relating to the pen type input device 200 is already displayed is beyond a range of the display screen 101, the determination section 19 determines that the decision display position may not be changed in this case.

Meanwhile, the CPU 11 controls a light emitting element and a light receiving element of the scanning section 9.

As described above, the touch panel section 100B is an infrared intercepting type touch panel. That is, the position of such light shielding object (the pen type input devices 200 and 300) is detected by detecting the light shielding when tips of the pen type input devices 200 and 300 touch the display screen 101 of the display section 100A. In other words, the scanning result, that is, the signal (an intensity signal) obtained from the light receiving element is transmitted to the control section 1 and the coordinate detection section 12 detects the coordinates of the light shielding object based on the optical intensity. Therefore, the touch panel section 100B receives the input of the position designation, characters, line drawing, and the like on the display section 100A (the display screen 101) from the user.

The scanning section 9 of the touch panel section 100B scans light (hereinafter, referred to as infrared light) of infrared rays along the display screen 101 of the display section 100A. The scanning section 9 further includes a light emitting section 91 which has a plurality of light emitting elements irradiating the infrared light, a light receiving section 92 which has a plurality of light receiving elements receiving the infrared light from the corresponding light emitting elements, an address decoder 93 which assigns a light emitting signal and a light receiving signal from the control section 1 (the CPU 11) to each of the light emitting sections 91 and light receiving sections 92, and an A/D converter 94 which converts an analog signal from the light receiving section 92 used to detect the light shielding into a digital signal.

FIG. 5 is a functional block diagram for explaining the scanning processing of light in the touch panel section 100B of the interactive whiteboard 100 according to the embodiment of the present invention.

The light emitting section 91 includes a multiplexer (not illustrated) and each of the light emitting elements is connected to the multiplexer. In addition, the light receiving section 92 also has the multiplexer (not illustrated) and each of the light receiving elements is connected to the multiplexer. Further, each of the light emitting elements of the light emitting section 91 is configured to correspond to (face) any one light receiving element of the light receiving section 92.

The CPU 11 of the control section 1 outputs the light emitting signals, which allow the plurality of light emitting elements to emit light, to an address decoder 93A and outputs the light receiving signals, which allow the plurality of light receiving elements to receive light, to an address decoder 93B. The address decoder 93A outputs a signal specifying any light emitting element relating to light emission among the light emitting elements to the light emitting section 91 depending on the signal from the CPU 11 and the address decoder 93B outputs a signal specifying a light receiving element corresponding to the specified light emitting element among the light receiving elements to the light receiving section 92 depending on the signal from the CPU 11.

Such a specified light emitting element emits infrared light and the corresponding light receiving element receives the infrared light. In this case, the intensity signal which represents the intensity of the infrared light received by the light receiving element as a voltage value is output to the A/D converter 94. The A/D converter 94 converts the intensity signal into, for example, a digital signal of 8 bits and outputs the converted intensity signal to the control section 1. To acquire the intensity signal from all the light receiving elements, the control section 1 sequentially repeats the processing of acquiring the intensity signal from each of the light receiving elements.

The CPU 11 of the control section 1 calculates an amount of light received by the light receiving element based on the intensity signal acquired from each of the light receiving elements. When the calculated amount of received light exceeds a prescribed threshold value, the CPU 11 determines that the optical path of the infrared light received by the light receiving element is not blocked. Further, when the calculated amount of received light is the prescribed threshold value or less, it is determined that the optical path of the infrared light received by the light receiving element is blocked.

The coordinate detection section 12 detects a contact position of the pen type input devices 200 and 300 on the display screen 101 based on the determination result of the CPU 11. That is, the coordinate detection section 12 specifies the light receiving element in which the optical path of the infrared light is blocked and performs the processing of detecting the positions of the tips, that is, contact coordinates of the pen type input devices 200 and 300 on the display screen 101 of the display section 100A based on the position of the specified light receiving element.

Hereinafter, the scanning and the detection of the contact position of the light shielding object will be described in detail. FIG. 6 is a view for explaining the scanning and the detection of the contact position with the light shielding objects in the interactive whiteboard 100 according to the embodiment of the present invention.

As described above, the display screen 101 of the display section 100A has a rectangular shape, and a plurality of light emitting elements 911, 911, . . . which are arranged in parallel along the edge of the display section 100A are disposed at the right and lower portion of the display screen 101 in the drawing. The light emitting element 911 is, for example, a light emitting diode (LED) which emits infrared light. In the drawing, the optical path of the infrared light emitted by each of the light emitting element 911 is illustrated by a solid line arrow.

The plurality of light emitting elements 911, 911, . . . at the right are disposed so that the optical paths of the infrared light emitted by each of the light emitting element 911 are parallel with each other along the display screen 101 and the plurality of light emitting elements 911, 911, . . . at the lower portion are also disposed in the same manner.

That is, in FIG. 6, the lower light emitting elements 911, 911, . . . arranged in parallel in a horizontal direction (an x-axis direction) and the plurality of right-sided light emitting elements 911, 911, . . . arranged in parallel in a vertical direction (a y-axis direction) have optical paths which are disposed so as to be orthogonal to each other.

Further, the display screen 101 of the display section 100A includes a plurality of light receiving elements 921, 921, . . . which are provided at a position facing the light emitting elements 911, 911, . . . .

That is, the plurality of light receiving elements 921, 921, . . . are arranged in parallel along an edge of the display screen 101 of the display section 100A at the left and upper thereof. The light receiving element 921 is a light receiving diode which receives the infrared light. The infrared light from the light emitting elements 911, 9111 is received by the light receiving elements 921, 921, . . . which are disposed to be opposite thereto.

Similar to the case of the light emitting element, the upper light receiving elements 921, 921, . . . and the left-sided light receiving elements 921, 921, . . . are provided so that the optical paths of the infrared light to be received are orthogonal to each other.

In the display screen 101 of the display section 100A, the scanning section 9 allows the light emitting elements 911 to sequentially emit light one by one from one end to the other end in the X-axis direction or from one end to the other end in the Y-axis direction, thereby the contact position of the pen type input devices 200 and 300 on the display screen 101 of the display section 100A is detected as described above.

The pen type input devices 200 and 300 are configured to communicate with the interactive whiteboard 100 (through the communication section 5) and instruct the interactive whiteboard 100 to perform drawing. Hereinafter, the pen type input devices 200 and 300 will be described. Further, since the pen type input device 200 and the pen type input device 300 have the same configuration, only the pen type input device 200 will be described.

When a user performs drawing using the pen type input device 200, the pen type input device 200 includes a contact portion (not illustrated) which contacts the display screen 101 of the display section 100A and a communication section (not illustrated) which transmits data (drawing instruction data) relating to drawing instructions. The drawing instruction includes, for example, turn on/off information of the pen type input device 200, thickness information of the diagrammatic drawing displayed by drawing or the like.

The communication section (hereinafter, referred to as an input device side communication section) of the pen type input device 200 is configured to wirelessly communicate via Bluetooth, ZigBee, or the like, corresponding to the communication section 5 of the interactive whiteboard 100.

For example, when the user grips the pen type input device 200 and performs drawing on the display screen 101 of the display section 100A, a contact pressure is measured by the contact between the tip of the contact portion and the display screen 101. In other words, at the time of the contact, the pressure (hereinafter, referred to as a writhing pressure) at the contact portion is detected by, for example, a distortion sensor and the detected writing pressure is transmitted to the interactive whiteboard 100 through the input device side communication section. The thickness of a line to be drawn, or the like may be changed by the writing pressure.

Further, the input device side communication section transmits the identification to the interactive whiteboard 100 every time the contact portion contacts the display screen 101.

Further, the above-described coordinate detection section 12, the light shielding object management section 13, the information integration section 14, the acquisition section 15, the drawing section 16, the display control section 17, the decision section 18, the determination section 19, and the selection receiving section 20 may be configured by hardware logic or may be configured by a software by allowing the CPU 11 to execute a prescribed program.

FIG. 7 is a flow chart for explaining the drawing processing performed by the interactive whiteboard 100 according to the embodiment of the present invention. For convenience of description, the case in which two users use the pen type input device 200 and the pen type input device 300 will be described by way of example.

For example, when one user stands in front of the display screen 101, having the pen type input device 200 and another user stands in front of the display screen 101, having the pen type input device 300, the communication can be performed by a pairing between the input device side communication sections of the pen type input device 200 and the pen type input device 300 and the communication section 5 of the interactive whiteboard 100.

The CPU 11 detects, for example, the number N of receivable input devices based on the number of pen type input devices which perform a response at the time of the pairing (step S101). According to the present embodiment, the pen type input device 200 and the pen type input device 300 are used and the number of receivable input devices is ‘2’.

Next, the CPU 11 determines whether the number N of receivable input devices is larger than ‘0’ (step S102).

When the CPU 11 determines that the number N of receivable input devices is smaller than ‘0’ (step S102: NO), that is, if it is determined that no receivable input device is present, the processing returns to the step S101.

Further, according to the present embodiment, since the number N of receivable input devices is ‘2’, the CPU 11 determines that the number N of receivable input devices is larger than ‘0’ (step S102: YES) and determines whether the operation of an N-th input device is performed (step S103). Hereinafter, For convenience of description, the pen type input device 200 and the pen type input device 300 are each described as a first input device and a second input device, respectively.

In such a determination, as described above, their own identification data of the pen type input devices 200 and 300 are transmitted to the interactive whiteboard 100 and the acquisition section 15 of the interactive whiteboard 100 acquires the identification data every time each contact portion contacts the display screen 101. In this case, the drawing instruction data of such a pen type input device are also transmitted to the interactive whiteboard 100. The interactive whiteboard 100 receiving the data stores the drawing instruction data corresponding to each identification data of the pen type input device in the storage section 6.

Therefore, in the step S103, the CPU 11 performs such a determination based on the storage contents of the storage section 6.

If it is determined that the operation of the N-th input device is not performed (step S103: NO), in other words, when the operation of the second input device is not performed since the ‘N’ is actually ‘2’, the CPU 11 substitutes ‘N−1’ into ‘N’ (step S109), and the processing returns to the step S102.

Since ‘N’ is ‘2’, ‘N−1’ is 1 and ‘N’ actually becomes T. Next, ‘N’ is set to be ‘1’ and thus the processing in the steps S102 and S103 is performed.

When ‘N’ is ‘1’, and in step S103, if it is determined that the operation of the N-th input device is not performed (step S103: NO), in the step S109, ‘N’ becomes actually ‘0’. Therefore, when the processing returns to the step S102, it is determined that the number N of receivable input devices is not larger than ‘0’ (step S102: NO), and the processing returns to the step S101.

That is, in connection with the operation of the first input device to the N-th input device, the corresponding processing is performed for each sequential input device and when the processing up to the N-th input device ends, the number N of receivable input devices are detected again and thus the change in the number N of receivable input devices is prepared.

Meanwhile, in the step S103, if the CPU 11 determines that the operation of the N-th input device is performed (step S103: YES), the processing of the subroutine performing the display of the setting menu of the N-th input device and the drawing is executed (step S104).

FIG. 8 is a flow chart for explaining the display of the setting menu and the drawing performed by the interactive whiteboard 100 according to the embodiment of the present invention.

The coordinate detection section 12 detects the position of the N-th input device based on the signal from the touch panel section 100B (step S201). The detection of the coordinates by the coordinate detection section 12 is already described and therefore a detailed description thereof will be omitted.

Next, the display control section 17 executes the processing of the subroutine displaying the setting menu at the position decided by the decision section 18 based on the detection result of the position of the N-th input device by the touch panel section 100B (step S202). The processing will be described in more detail below.

Next, the CPU 11 determines whether the drawing instruction is received from the N-th input device (step S203). Such a determination is performed by deciding whether the CPU 11 receives the drawing display data through monitoring the storage section 6 or the communication section 5.

If it is determined that the CPU 11 receives the drawing instruction from the N-th input device (step S203: YES), the drawing section 16 generates an image to be displayed on the display screen 101 based on the received drawing instruction data by using the applications for executing the drawing processing stored in the storage section 6 and outputs the generated image to the display screen 101, thereby performing drawing processing (step S204).

Meanwhile, if it is determined that the drawing instruction is not received from the N-th input device (step S203: NO), the CPU 11 determines whether the drawing instruction is an instruction relating to the setting menu (step S205). That is, the CPU 11 determines whether any soft key of the setting menu is operated based on the signal from the touch panel section 100B.

If it is determined that the instruction is not an instruction relating to the setting menu (step S205: NO), the CPU 11 returns the processing to the step S203.

Further, if it is determined that the instruction is an instruction relating to the setting menu (step S205: YES), the CPU 11 determines whether such instruction is an instruction of intent to end drawing (step S206). Such a determination is performed by allowing the CPU 11 to determine whether the soft key of the setting menu operated by the user (N-th input device) is the ‘ending’ soft key based on the signal from the touch panel section 100B.

If it is determined that the instruction relating to the setting menu is an instruction of intent to end drawing (step S206: YES), the CPU 11 stores receiving the instruction of intent to end drawing in the RAM 3 (step S208) and ends the processing.

Meanwhile, if the CPU 11 determines that the instruction relating to the setting menu is not the instruction of intent to end drawing (step S206: NO), it is considered that the soft key other than the ‘ending’ soft key is operated by the user (N-th input device).

Therefore, in this case, the CPU 11 specifies the soft key operated by the user (N-th input device) based on the signal from the touch panel section 100B and changes the setting (color, deletion, or the like) related to drawing depending on the specified result (step S207).

FIG. 9 is an exemplified diagram illustrating an example of the display of the setting menu and the drawing performed by the interactive whiteboard 100 according to the embodiment of the present invention.

According to the present embodiment, as described above, the case in which two users use the pen type input device 200 and the pen type input device 300, respectively will be described by way of example. Therefore, as illustrated in FIG. 9, the corresponding setting menu 200A is displayed in the left direction of the pen type input device 200 which performs drawing at the left of the display screen 101 and the corresponding setting menu 300A is displayed in the right direction of the pen type input device 300 which performs drawing at the right.

The embodiment of the present invention will be described again with reference to FIG. 7. As described above, after the display of the setting menu of the N-th input device and drawing are performed, it is determined whether the CPU 11 receives the instruction of intent to end drawing (step S105). The CPU 11 performs such a determination by confirming whether the RAM 3 stores the intent to receive the instruction.

If it is determined that the instruction of intent to end drawing is not received (step S105: NO), the CPU 11 moves the processing to step S109.

Further, if it is determined that the CPU 11 receives the instruction of intent to end drawing (step S105: YES), the display control section 17 displays the ending confirmation notice image on the display screen 101, thereby notifying the confirmation of the ending (step S106).

For example, when the ‘ending’ soft key of the setting menu is operated in order for the user of the pen type input device 200 to end drawing, the display control section 17 displays the ending confirmation notice image near the setting menu 300A to notify the user of the pen type input device 300 of the confirmation of the ending.

In this case, the selection receiving section 20 receives the selection on whether or not to end drawing from the user of the pen type input device other than the pen type input device 200 through the ending confirmation notice image.

The CPU 11 determines whether the selection of the intent to end drawing is received from the user of all the pen type input devices excluding the pen type input device 200 based on the selection received by the selection receiving section 20 (step S107).

For example, when the users of all the pen type input devices (only the pen type input device 300 in the present embodiment) excluding the pen type input device 200 select YES by operating the soft key of the ending confirmation notice image, the CPU 11 determines that the selection of the intent to end drawing is received from the users of all the input devices excluding the pen type input device 200 (step S107: YES), and the drawing processing ends (step S108).

Meanwhile, the CPU 11 determines that the selection of the intent to end drawing is not received from the users of all the pen type input devices excluding the pen type input device 200 (step S107: NO), the processing returns to the step S109.

FIG. 10 is a flow chart for explaining display of the setting menu performed by the interactive whiteboard 100 according to the embodiment of the present invention. For convenience of description, the case in which a setting menu 300A relating to the pen type input device 300 is displayed in the state in which the setting menu 200A relating to the pen type input device 200 is already displayed on the display screen 101 will be described. Further, the display position of the setting menu 200A is stored in the storage section 6.

When the touch panel section 100B detects the position of the pen type input device 300 on the display screen 101, the decision section 18 decides the position (the decision display position) at which the corresponding setting menu 300A to be displayed based on the detected position of the pen type input device 300 (step S301).

The determination section 19 determines whether another setting menu is already displayed at the decision display position at which the setting menu 300A is to be displayed (step S302) by comparing the decision display position decided by the decision section 18 with the display position of the setting menu 200A stored in the storage section 6.

If the determination section 19 determines that another setting menu is not displayed at the decision display position (step S302: NO), the display control section 17 displays the setting menu 300A at the decision display position (step S305).

Further, if it is determined that another setting menu is already displayed at the decision display position (step S302: YES), the determination section 19 determines whether the decision display position may be changed (step S303). Such a determination performed by the determination section 19 is already described and therefore the detailed description thereof will be omitted.

If the determination section 19 determines that the decision display position may be changed (step S303: YES), the display control section 17 displays the setting menu 300A at another changed position, which is not the position determined in step S301 (step S304).

FIG. 11 is a diagram for explaining display of the setting menu performed by the interactive whiteboard 100 according to the embodiment of the present invention.

As illustrated in FIG. 11, there may be the case in which the setting menu 200A relating to the pen type input device 200 is already displayed near a decision display position L1 of the setting menu 300A determined by the decision section 18. In this case, to avoid overlapping with the setting menu 200A, the decision section 18 re-determines, for example, a position L2 at a prescribed distance separated from the position of L1 more to the right and the determination section 19 again determines whether another setting menu is displayed at the re-determined decision display position. The display control section 17 displays the setting menu 300A at the re-decided decision display position L2 depending on the determination result.

Further, if the determination section 19 determines that the decision display position may not be changed (step S303: NO), the display control section 17 displays the setting menu 300A in a semi-transparent manner at the decision display position determined in step S301 over the setting menu 200A (step S306). Such a determination performed by the determination section 19 is already described and therefore the detailed description thereof will be omitted.

As described above, the case in which a plurality of users each performs the drawing using the pen type input device is described by way of example, but the interactive whiteboard 100 according to the present invention is not limited thereto. For example, the interactive whiteboard 100 may be configured so that the drawing may be performed by the user's finger tip and in this case, the interactive whiteboard may be configured that the setting menu which may correspond to the input of the finger tip may be displayed.

Further, as described above, the case in which the same setting menu is displayed for the plurality of users is described by way of example, but the embodiment of the present invention is not limited thereto and a setting menu may be displayed for each user with different attributes (size, color, or the like).

In the present invention, the drawing device 100 displays images on a display screen 101 based on instructions received from a plurality of drawers 200,300 each having its own identification data and issuing the instructions relating to drawings, wherein the drawing device is characterized by including: a touch panel section 100B configured to detect positions of respective drawers 200,300 on the display screen 101; and a display control section 17 configured to display setting receiving images 200A and 300A for receiving settings relating to drawings, by as many as the number of drawers based on the detected positions of the drawers 200,300.

According to the embodiments of the present invention, it is possible to cope with the case in which the plurality of drawers are used and when the drawing is performed, it is possible to increase the convenience of each user.

In the present invention, the drawing device is characterized by including an acquisition section 15 configured to acquire identification data from the respective drawers 200,300, and the display control section 17 displays the corresponding setting receiving image 200A and 300A within a specific range from positions of the respective drawers 200,300 based on the acquired identification data and the detection result of the touch panel section 100B.

According to the present invention having above configuration, since the setting receiving image is displayed within the specific range from the positions of the respective drawers, when settings relating to drawing are performed, it is possible to increase the convenience of each user.

In the present invention, the drawing device is characterized by including: a decision section 18 configured to decide a position at which the setting receiving image 200A and 300A is displayed; and a determination section 19 configured to determine whether to change the position when another setting receiving image has been already displayed at the position decided by the decision section 18, and if the determination section 19 determines that the position may be changed, the decision section 18 changes the position.

According to the present invention having above configuration, if the determination section determines that the position may be changed, the decision section changes the already-decided position, thereby it is possible to avoid overlapping with other setting receiving images that have already been displayed.

In the present invention, the drawing device is characterized in that, if the determination section 19 determines that the position may not be changed, the display control section 17 displays the setting receiving image to be displayed in a semi-transparent manner.

According to the present invention having above configuration, if the determination section determines that the position may not be changed, the display control section displays the setting receiving image to be displayed in a semi-transparent manner over the other setting receiving image that have already been displayed, thereby it is possible to improve the inconvenience of the user at the time of using the setting receiving image.

In the present invention, the drawing device is characterized by including a selection receiving section 20 configured to receive a selection as to whether another drawer 200,300 ends drawing when an instruction to end drawing relating to any drawer 200,300 is received, and the execution of drawing is ended based on the selection received by the selection receiving section 20.

According to the present invention having above configuration, when the instruction to end drawing relating to one drawer is received, for example, only when the selection receiving section receives the selection of the intent to allow all the other drawers to end drawing, the execution of drawing ends, thereby it is possible to prevent sudden attack from the users of other drawers.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A drawing device having a display screen for displaying images based on instructions received from a plurality of drawers each having its own identification data and issuing the instructions relating to drawings, the drawing device comprising:
a touch panel section configured to detect positions of respective drawers on the display screen; and
a display control section configured to display setting receiving images for receiving settings relating to drawings, by as many as the number of drawers based on the detected positions of the drawers.

2. The drawing device according to claim 1, further comprising an acquisition section configured to acquire identification data from the respective drawers,
wherein the display control section displays the corresponding setting receiving image within a specific range from positions of the respective drawers based on the acquired identification data and the detection result of the touch panel section.

3. The drawing device according to claim 1, further comprising: a decision section configured to decide a position at which the setting receiving image is displayed; and
a determination section configured to determine whether to change the position when another setting receiving image has been already displayed at the position decided by the decision section,
wherein if the determination section determines that the position can be changed, the decision section changes the position.

4. The drawing device according to claim 3, wherein if the determination section determines that the position cannot be changed, the display control section displays the setting receiving image to be displayed in a semi-transparent manner.

5. The drawing device according to claim 1, further comprising a selection receiving section configured to receive a selection as to whether another drawer ends drawing when an instruction to end drawing relating to any drawer is received,
wherein the execution of drawing is ended based on the selection received by the selection receiving section.

6. A drawing device having a display screen for displaying images based on instructions received from a plurality of drawers each having its own identification data and issuing the instructions relating to drawings, the drawing device comprising:
a touch panel section configured to detect positions of respective drawers on the display screen; and
a display control means configured to display setting receiving images for receiving settings relating to drawings, by as many as the number of drawers based on the detected positions of the drawers.

7. The drawing device according to claim 6, further comprising an acquisition means configured to acquire identification data from the respective drawers,
wherein the display control means displays the corresponding setting receiving image within a specific range from positions of the respective drawers based on the acquired identification data and the detection result of the touch panel section.

8. The drawing device according to claim 6, further comprising: a decision means configured to decide a position at which the setting receiving image is displayed; and
a determination means configured to determine whether to change the position when another setting receiving image has been already displayed at the position decided by the decision means,
wherein if the determination means determines that the position can be changed, the decision means changes the position.

9. The drawing device according to claim 8, wherein if the determination means determines that the position cannot be changed, the display control means displays the setting receiving image to be displayed in a semi-transparent manner.

10. The drawing device according to claim 6, further comprising a selection receiving means configured to receive a selection as to whether another drawer ends drawing when an instruction to end drawing relating to any drawer is received,
wherein the execution of drawing is ended based on the selection received by the selection receiving means.

11. A display method displaying setting receiving images for receiving settings relating to drawings in a drawing device having a display screen for displaying images based on instructions received from a plurality of drawers each having its own identification data and issuing the instructions relating to drawings, the method comprising:
a step of detecting positions of respective drawers on the display screen; and
a step of displaying the setting receiving images by as many as the number of drawers based on the detected positions of the drawers.

12. A non-transitory computer-readable recording medium recorded with a computer program which causes a computer to display setting receiving images for receiving settings relating to drawings, the computer constituting a drawing device which has a display screen for displaying images based on instructions received from a plurality of drawers each having its own identification data and issuing the instructions relating to drawings, wherein the computer program comprising:
a step of detecting, by the computer, positions of respective drawers on the display screen; and
a step of displaying, by the computer, the setting receiving images by as many as the number of drawers based on the detected positions of the drawers.
